(19) United States
(12) Patent Application Publication
(10) Pub. No.: US 2025/0334512 A1
(43) Pub. Date: Oct. 30, 2025

(54) DEVICES FOR SHORT-WAVE INFRARED BOTTOM-UP ILLUMINATION AND IMAGING OF TISSUE SAMPLES

(71) Applicants: Zhongming LI, Mountain View, CA (US); Cision Vision, Inc., Mountain View, CA (US)

(72) Inventor: Zhongming LI, Mountain View, CA (US)

(73) Assignee: Cision Vision, Inc., Mountain View, CA (US)

(21) Appl. No.: 18/866,023

(22) PCT Filed: May 18, 2023
(86) PCT No.: PCT/US2023/022684

§ 371 Date: Nov. 14, 2024

Related U.S. Application Data
(60) Provisional application No. 63/343,471, filed on May 18, 2022.

(51) Int. Cl. G01N 21/359; G01N 21/01; G01N 21/39; G02B 21/06; G02B 21/36

(52) U.S. Cl. CPC G01N 21/359; G01N 21/01; G01N 21/39; G02B 21/06; G02B 21/36

(57) ABSTRACT

A tabletop device for short-wave infrared (SWIR) imaging of tissue comprises a main housing defining an interior cavity and an comprising upper surface having a transparent substrate thereon. A first SWIR light source inside the main housing generates illumination light that is directed through the bottom of the transparent substrate to be incident on a tissue sample. An image sensor inside the main housing is configured to collect reflected SWIR light that is reflected by the tissue. One or more processors inside the main housing are communicatively coupled to the image sensor and configured to generate an image of the tissue sample based on the reflected SWIR light. A display mounted to the main housing displays the generated image in real-time.

### CROSS-REFERENCE TO RELATED APPLICATION

This application claims priority to and the benefit of U.S. Provisional Patent Application No. 63/343,471, filed May 18, 2022, the entire content of which is incorporated herein by reference.

### FIELD

The present disclosure relates generally to imaging systems, and more specifically to imaging systems using short-wave infrared (SWIR) illumination.

### BACKGROUND

Currently, there are a number of imaging modalities to image biological tissue, such as tissue samples that have been biopsied from the body. Imaging biological tissue may be useful for a number of diagnostic and/or investigative application, including assessing resected tissue to locate tissue features and/or biopsy clips that may enable practitioners to make assessments about the state of the tissue, the health of the tissue, and/or the health of the patient from whom the tissue was resected.

In some use cases, biological tissue may be imaged in order to locate and assess of lymph nodes. Lymph nodes, also known as lymph glands, are oval-shaped organs that are widely present throughout the human and animal bodies. In some embodiments, lymph nodes may be present in resected tissue, and the resected tissue may be imaged to locate and assess one or more lymph nodes therein. In recent years, cross sectional imaging modalities, including Computational Tomography (CT) and Magnetic Resonance Imaging (MRI), have become increasingly popular, in replacement of lymphography in lymph node visualization. Ultrasound and Positron Emission Tomography (PET) have also been demonstrated to be useful. Although with these techniques mentioned above, doctors are able to identify lymph nodes and make a reasonably accurate judgment of their conditions, they are general-purpose imaging modalities, so their working mechanisms are not designed to give the best contrast for lymph nodes specifically, unless specific contrasting agents are injected. As a result, other organs and tissues show up in these images with the same or sometimes even better contrast compared to lymph nodes, causing distractions to the task of finding and examining the lymph nodes. These general-purposed imaging modalities are not only not specific to lymph nodes, but also possess their own critical drawbacks. CT involves X-ray exposure and PET involves radioactive agents, which need to be carefully controlled in prevention of health hazards. MRI requires expensive instrumentation and is not compatible with patients with metal implants. Ultrasound provides low imaging contrast and resolution mainly because of its long imaging wavelength.

In some use cases, biological tissue may be imaged in order to locate biopsy clips that have been placed at a biopsy sites so that the pathological conditions of the biopsy site can be tracked. It is of critical importance to locate biopsy clips inside surgically resected specimens, so that the surgeons, pathologists, and oncologists can fully understand the conditions of the patients' tumor before and after the surgery. Biopsy clips, such as breast biopsy clips, can be as small as 2 mm in length and 1 mm in width, while breast specimens can be as large as 200 mm in length and 30,000,000 mm3 in volume. Thus, locating breast biopsy clips according to known techniques may require manual palpation of the breast tissue. The process for locating breast biopsy clips can be assisted by the use of large, cabinet-sized X-ray machines

### SUMMARY

As described above, known techniques for imaging and assessing biological tissue-including imaging and assessing resected tissue, imaging and assessing characteristics of said resected tissue, and/or imaging and assessing biopsy clips within said resected tissue-include using techniques such as CT, MRI, ultrasound, and/or x-ray imaging.

However, known techniques for imaging and/or assessing biological tissue have various drawbacks. First, non-imaging based methods for assessing tissue have various drawbacks. For example, locating breast biopsy clips via manual palpitation of breast tissue is imprecise and time-consuming, taking hours to process a single case.

Furthermore, known-imaging-based techniques for assessing tissue also have various drawbacks. For example, the use of x-ray imaging technology and/or MRI technology can be prohibitively expensive. Additionally, use of x-ray imaging technology requires compliance with radiation protocols, which are inconvenient and expose handlers to potential work hazards.

Further still, the use of known imaging modalities may be poorly suited for the various medical use cases, such as imaging of lymph nodes or locating of biopsy clips. For example, lymph nodes may not be easily visible under standard white-light optical imaging, and detection of lymph nodes deep within a tissue sample may not be possible according to known techniques due to specular reflections of the superficial portions of the tissue sample. With respect to biopsy clips, the clips may be too small to be imaged according to known techniques and modalities, and they may not be able to be seen when they are located deep within a tissue sample.

Further still, the form factors of known imaging equipment may be poorly suited for easy and effective use by medical practitioners. For example, while certain imaging equipment intended for laboratory use may provide a reasonably wide range of functionality, medical practitioners may not have the knowledge or skills to configure and use said imaging equipment. Furthermore, known imaging equipment may be configured for imaging of small biological samples, such as a sample on a microscopy slide, and may be poorly suited for imaging of a large resected tissue sample, such as a breast tissue sample that is only partially slices and remains partially intact. Further still, known imaging equipment may not be able to be used with resected tissue samples in a medical setting without the optical components of the system equipment quickly becoming contaminated and unusable.

Finally, the form factors of known imaging equipment are not suitable for performing specimen preparation operations, including specimen cutting and slicing, in an area that is immediately adjacent to an area in which specimen imaging is performed. In known arrangements, cutting boards are spaced apart from imaging equipment, requiring specimen preparation to be performed in a different area than imaging, which requires movement of the prepared specimen throughout the laboratory space and leads to inefficiencies and the opportunity for inadvertent specimen damage or contamination.

Accordingly, there is a need for improved systems and methods for imaging of biological samples. Particularly, there is a need for systems and methods for effectively and accurately imaging biological samples including lymph nodes, microcalcifications, and/or biopsy clips. There is a need for such systems that are affordable, lightweight, portable, able to be used by a medical practitioner who is not an optics expert, and able to be used in a medical setting with biological tissue samples without fouling or otherwise compromising the system. Disclosed herein are systems and methods that may address the above-identified need(s).

Disclosed herein are tabletop imaging devices that use short-wave infrared (SWIR) illumination for imaging of tissue samples, including imaging of calcifications, imaging of lymph nodes, and/or imaging of biopsy clips disposed in tissue samples. A tabletop imaging device, as described herein, may comprise a housing with a transparent substrate forming part of an upper surface of the housing. Imaging components for providing illumination light and for collecting light to be imaged (e.g., reflection light, emission light) may be disposed inside the housing, such that illumination light is provided from below the substrate and imaging light is collected from below the substrate. The housing of the device may form a closed and sealed interior space, protecting the imaging components disposed therein from contamination or interference from fluids, gases, dust, debris, air flows, temperature fluctuations, and/or ambient light. A volumetric region above the substrate may be free from occlusion by any other components of the device, such that the region may be easily accessed by the user for placement and manipulation of the tissue both before and during imaging. A user such as a physician may be able to place a tissue sample substrate on the upper surface of the device and manipulate and position the tissue sample as desired. Once the tissue sample is positioned, and/or as the tissue sample is being positioned and repositioned, the tissue sample may be illuminated and imaged from below, which the imaging components are protected from contamination by fluid or other components of the tissue sample above. Furthermore, as described herein, the form factor and size of the devices described herein may make the devices portable and amenable to use in an open benchtop setting.

In some embodiments, the device may include a display mounted to the main body of the device and configured to display images generated by imaging the tissue samples placed thereon. One or more processors of the device may be configured to cause images captured by the device to be displayed on the display in real time, such that a user may reposition and/or otherwise manipulate a tissue sample that is placed on the transparent substrate, and the user may be able to view the images of the tissue sample generated in real time while manipulating the tissue. In some embodiments, the display may be positioned behind the volumetric region located above the substrate, such that a user standing in front of the device and manipulating a tissue sample atop the substrate may easily move his or her gaze from the substrate to the display. This may allow the user to efficiently and effectively locate portions of the sample that the user is seeking to identify, such as tissue calcifications, lymph nodes, and/or biopsy clips.

In some embodiments, in addition to SWIR illumination, the device may be configured for white-light illumination. The device may include a white-light illumination source disposed in the device housing, wherein the white-light illumination source illuminates the sample from below the substrate. Reflected white light from the tissue sample may be collected by the same sensor that collects reflected SWIR light, or it may be collected by a second image sensor that is also disposed in the device housing below the substrate. The one or more processors of the device may be configured to use the reflected and detected white light to (a) generate an image based on both reflected white light and on reflected SWIR light, and/or to (b) generate a white-light image in addition to a separate SWIR light image (or in addition to a separate combined SWIR-white-light image). In the case of generating a separate white-light image, the white-light image and the SWIR image (or the combined SWIR-and-white-light image) may be displayed simultaneously with one another in real time on the display, for example by being displayed side by side or by

SWIR illumination wavelengths may be uniquely suitable for the applications described herein, particularly for locating breast biopsy clips, for at least two reasons. First, SWIR illumination light scatters much less than visible light or near-infrared (NIR) light (e.g., between 400-1000 nm), as the amount of scattering decreases exponentially with increases in wavelength of light. Thus, SWIR illumination light may effectively penetrate breast tissue without being scattered. Second, SWIR illumination light has characteristic absorption peaks of many different chemicals that are commonly present in breast tissue, such as lipids, water, and collagen, allowing for unique contrasts to be created by these chemicals when imaging tissue components including those chemicals. Additionally, the use of SWIR illumination light may avoid the need for radiation protocols, which are inconvenient and expose the handlers to potential work hazards, as would be required with the use of equipment operating in the x-ray range.

In some embodiments, the device may comprise an integrated cutting board positioned nearby and/or immediately adjacent to an imaging region. For example, a cutting board may be inlaid on an upper surface of the device, immediately adjacent to a transparent substrate on which imaging is performed. The upper surface of the cutting board may be flush with the surrounding upper surface of the device and/or with the upper surface of the transparent substrate, such that a specimen may be cut on the cutting board and then may be immediately and safely slid from the cutting board onto the transparent substrate for imaging.

In some embodiments, a tabletop device for short-wave infrared (SWIR) imaging of tissue, comprising: a main housing defining an interior cavity and an comprising upper surface, wherein the upper surface comprises a transparent substrate configured to support a tissue sample placed on the transparent substrate atop the main housing of the device; a SWIR light source disposed inside the main housing of the device, wherein the SWIR light source is configured to generate SWIR illumination light that is directed through the bottom of the transparent substrate to be incident on the tissue sample disposed atop the transparent substrate; an image sensor disposed inside the main housing of the device, wherein the image sensor is configured to collect reflected SWIR light that is reflected by the tissue and passes from above the transparent substrate through the transparent substrate to be incident upon the image sensor; one or more processors disposed inside the main housing of the device, wherein the one or more processors are communicatively coupled to the image sensor and configured to generate an image of the tissue sample based at least in part on the reflected SWIR light; and a display mounted to the main housing, wherein the one or more processors are configured to cause the display to display the generated image in real-time.

In some embodiments, an open working space is provided above the transparent substrate, wherein the open working space is not occluded by any components of the device.

In some embodiments, the open working space has a footprint with an area of greater than or equal to 1600 cm².

In some embodiments: the transparent substrate is disposed on the upper surface of the main housing at a first vertical height and at a first depth in a front-back direction of the device; and all components of the device disposed closer to a front of the device than the first depth do not extend above the first height by a distance of greater than 1 cm.

In some embodiments: the transparent substrate is disposed on the upper surface of the main housing at a first vertical height and at a first depth in a front-back direction of the device; the display is mounted at a second vertical height that is higher than the first vertical height; and the display is mounted at a second depth that is further from a front of the device than the first depth.

In some embodiments, the transparent substrate is flush with an adjacent portion of the upper surface of the main housing.

In some embodiments, the transparent substrate forms a watertight seal with an adjacent portion of the upper surface of the main housing.

In some embodiments, the device comprises: a first polarizer positioned in an illumination light path of the SWIR illumination light and configured to impart a first polarization onto the SWIR illumination light; and a second polarizer positioned in a collection light path and configured to impart a second polarization onto the light that passes from the imaging region through the transparent substrate to be incident upon the image sensor; wherein the first polarization is substantially orthogonal to the second polarization.

In some embodiments, the device comprises a white-light source disposed inside the main housing of the device, wherein the white-light source is configured to generate white-light illumination light that is directed through the bottom of the transparent substrate to be incident on the tissue sample disposed on the transparent substrate simultaneously with the SWIR illumination light.

In some embodiments, the device comprises a white-light image sensor disposed inside the main housing of the device, wherein the white-light image sensor is configured to collect reflected white light that is reflected by the tissue and passes from above the transparent substrate through the transparent substrate to be incident upon the image sensor.

In some embodiments, the one or more processors are configured to generate the image of the tissue sample based at least in part on the reflected white light.

In some embodiments, the one or more processors are configured to: generate a white-light image of the tissue sample based at least in part on the reflected white light; and cause the display to display the generated white-light image simultaneously with display of the image generated based at least in part on the reflected SWIR light.

In some embodiments, the image sensor is configured to collect reflected white light that is reflected by the tissue and passes from above the transparent substrate through the transparent substrate to be incident upon the image sensor.

In some embodiments, the SWIR illumination light has a wavelength of one or more of: 800-1700 nm; 1000-1700 nm; 1500-1700 nm; 900-1300 nm; 1000-2600 nm; 960-1000 nm; 1180-1220 nm; 1530-1570 nm; 1680-1720 nm; 980-1200 nm; 1200-1550 nm; 1550-1700 nm; and 1700-2600 nm.

In some embodiments, the upper surface comprises a cutting board configured to support the tissue sample when placed on the cutting board atop the main housing of the device.

In some embodiments, the cutting board is recessed within a cavity formed in the upper surface.

In some embodiments, the cutting board is removable from the cavity.

In some embodiments, the cutting board is flush with an adjacent portion of the upper surface of the main housing.

In some embodiments, the cutting board forms a watertight seal with an adjacent portion of the upper surface of the main housing.

In some embodiments, the cutting board is flush with an adjacent portion of the transparent substrate.

In some embodiments, the cutting board forms a watertight seal with an adjacent portion of the transparent substrate.

Any one or more features of any of the above embodiments may be combined, in whole or in part, with one another and/or with any other features described herein.

### BRIEF DESCRIPTION OF THE FIGURES

These and other features will be more readily understood from the following detailed description taken in conjunction with the accompanying drawings.

FIG. 1A is a schematic view of an imaging device configured for SWIR illumination and for imaging of a tissue sample, in accordance with some embodiments.

FIG. 1B is a schematic view of an imaging device configured for SWIR illumination and for imaging of a tissue sample, wherein the imaging device comprises an integrated cutting board, in accordance with some embodiments.

FIG. 2 shows an imaging device configured for SWIR illumination and for imaging of a tissue sample, in accordance with some embodiments.

FIG. 3 shows an imaging device configured for SWIR illumination and for imaging of a tissue sample, in accordance with some embodiments.

FIG. 4 illustrates a computer according to some embodiments of the present disclosure.

### DETAILED DESCRIPTION

As described above, disclosed herein are tabletop imaging devices that use short-wave infrared (SWIR) illumination for imaging of tissue samples, including imaging of calcifications, imaging of lymph nodes, and/or imaging of biopsy clips disposed in tissue samples. In particular, disclosed herein are devices having optical components for illumination and detection disposed inside an interior region defined by a housing of a body of the device, wherein an upper surface of the body includes a transparent substrate on which the tissue sample to be imaged is placed. The optical components, disposed inside the housing of the body of the device, may be protected from contamination, physical interference, and ambient light. A volumetric region located above the substrate may be unoccluded by any components of the device, such that a user of the device may place a tissue sample to be imaged may be placed on top of the substrate and may freely manipulate the tissue sample both before and during imaging, without interfering with any of the optical components and without blocking the illumination light path or the collection light path. Additionally, the device may include a display mounted behind the substrate, such that the user of the device may view the display, which may display real-time images of the tissue sample, during manipulation of the tissue sample atop the substrate. The devices, described herein in greater detail, may provide for simple and effective imaging of tissue samples using SWIR illumination, which may allow for effective imaging of tissue characteristics and/or biopsy clips embedded within tissue samples without the need for expensive x-ray imaging equipment, adherence to radiation protocols, or configuration of complex and sensitive laboratory imaging equipment.

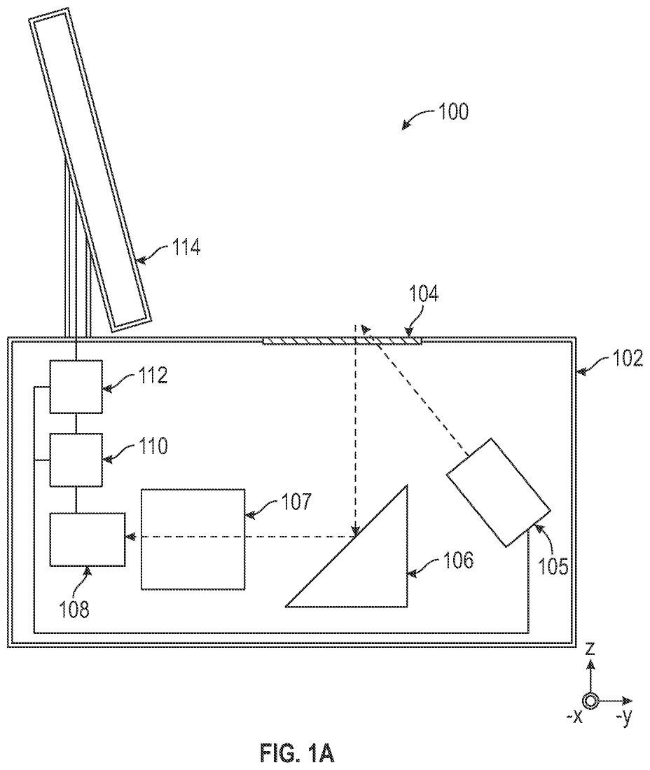

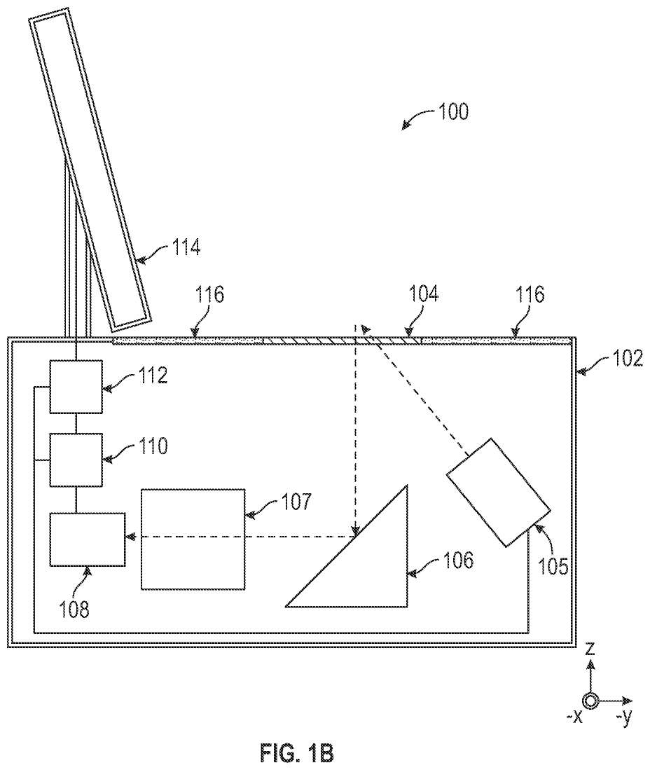

FIG. 1A is a schematic view of imaging device 100 configured for SWIR illumination and for imaging of a tissue sample, in accordance with some embodiments.

As shown, device 100 may comprise body 102 which may be include a housing enclosing an interior region. The interior region of body 102 may include one or components of device 100 including electronic components and/or optical components. In the embodiment shown, the interior region of body 102 includes: SWIR light source 105, reflective element 106, lens 107, image sensor 108, power module 110, and processor 112. As shown, device 100 may include substrate 104 which may be formed as a part of an upper surface of body 102. As further shown, device 100 may include display 114, which may be mounted to body 102 and electronically communicatively coupled to processor 112.

Body 102 may comprise an upper surface that faces upward toward an open space above the device. The upper surface of body 102 may comprise substrate 104, which may comprise any transparent or translucent material suitable for transmitting illumination light (e.g., SWIR light) and collection light (e.g., SWIR light) for imaging by device 100. Substrate 104 may be formed as a part of the upper surface by being flush with the upper surface or by being offset from the upper surface in the z-direction, upwards or downwards, by a distance of less than or equal to 1 mm, 0.5 mm, or 0.1 mm. Substrate 104 may be form a water-tight and/or air-tight seal with the upper surface of body 102, such that tissue samples may be placed on top of substrate 104 and body 102 and may be manipulated thereon without contaminating the interior region defined inside the housing of body 102. In some embodiments, substrate 104 may form a water-tight and/or air-tight seal with the upper surface of body 102 such that substrate 104 and/or body 102 may be easily cleaned without affecting components disposed in the interior region defined inside the housing of body 102.

In some embodiments, substrate 104 may be permanently formed as a part of the upper surface of body 102. In some embodiments, substrate 104 may be removable and replaceable in its position within the upper surface of body 102. In some embodiments, for example those in which substrate 104 may be removable and replaceable in its position within the upper surface of body 102, substrate 104 may be positioned inside a gasket that forms a seal between substrate 104 and the upper surface of body 102.

One or more optical components for illumination (and/or excitation) of a tissue sample may be disposed inside the interior space defined by the housing of body 102 and may be configured to direct said illumination (and/or excitation) light toward a tissue sample placed atop substrate 104. In the example shown, SWIR light source 105 is positions such that illumination light from SWIR light source travels directly from SWIR light source 105 to substrate 104 and passes through substrate 104 to be incident upon a tissue sample placed atop substrate 104. In some embodiment, one or more additional optical components for illumination may be included in device 100, such as one or more lenses, polarizers, filters, reflectors, or other optical components disposed in the illumination light path between SWIR light source 105 and substrate 104. In some embodiments, device 100 may include one or more additional light sources, for example disposed in parallel to SWIR light source 105, which may be configured to deliver illumination (and/or excitation) light of a different wavelength to the tissue sample.

One or more optical components for collection of light from the tissue sample disposed atop substrate 104 may be provided inside the interior space defined by the housing of body 102 and may be configured to direct collection (e.g., reflection and/or emission) light from the tissue sample atop substrate 104. The optical components for collection of light may include reflective element 106 configured to direct collection light toward and into lens 107; lens 107 configured to focus collection light onto sensor 108; and sensor 108 configured to detect the collection light.

Processor 112, which may be communicatively coupled to power module 110, image sensor 108, and/or illumination panel 108, may be disposed inside the interior space defined by the housing of body 102. Power module 110, which may be configured to supply power to one or more components of device 100, may be disposed inside the interior space defined by the housing of body 102. In some embodiments, power module 110 may include one or more batteries. Device 100 may be battery-powered, allowing user to swap out battery packs for device 100 and obviating the need to collect device 100 to line power. Device 100 may include an enclosure for batteries that is waterproof.

Components disposed inside the interior space defined by the housing of body 102 may be protected by the housing from contamination or interference from fluids, gases, dust, debris, air flows, temperature fluctuations, and/or ambient light.

SWIR light source 105 may be configured to provide SWIR illumination light to the tissue sample positioned atop substrate 104. SWIR light source 105 may be configured to generate said SWIR illumination light and/or to guide said SWIR illumination light. SWIR light source 105 may be communicatively coupled to processor 112 such that processor 112 can control functionality of SWIR light source 105. Processor 112 may be configured to turn SWIR light source 105 on and off, to adjust an intensity of light emitted from SWIR light source 105, to adjust a spatial pattern of light emitted from SWIR light source 105, to adjust a wavelength of light emitted from SWIR light source 105, and/or to adjust a temporal pattern of emission of light from SWIR light source 105. Device 100 may be configured to accurately and precisely control uniformity of SWIR illumination light and wavelength of SWIR illumination light provided by SWIR light source 105.

In some embodiments, illumination uniformity may be important, for example due to the small size of tissue features and/or biopsy clips to be detected by imaging. For example, if illumination is uneven, contrast resulting from tiny biopsy clips can be easily overshadowed by the noise caused by uneven illumination patterns. Thus, in some embodiments, SWIR light source 105 may be configured to provide uniform illumination across the imaging region, for example by implementing one or more of the arrangements described herein.

In some embodiments, SWIR light source 105 may comprise LEDs and/or glass diffusers. For example, custom-PCB boards may be used to surface-mount-LEDs with large emission angles, and glass diffusers with different grades may be used to diffuse the illumination provided by the LEDs. This approach may be advantageous due to ease of manufacture. The closer together the LEDs are provided, and the more effective the diffusers are at diffusing light, the more uniform the resulting illumination pattern may be.

In some embodiments, SWIR light source 105 may comprise a plurality of optical fibers. For example, SWIR illumination light may be coupled into a plurality of optical fiber bundles that may transmit said SWIR illumination light. The optical fiber bundles may then output the SWIR illumination light at or toward substrate 104. Optical fiber bundles may be used in combination with one or more glass diffusers as described above with respect to embodiments using LED illumination. In some embodiments, the ends of optical fibers may be positioned closer to one another than LEDs can be, therefore allowing for uniformity to be further increased.

In some embodiments, SWIR light source 105 may comprise one or more light guide panels. For example, SWIR light source 105 may comprise an acrylic light guide panel. A light guide panel may be configured to transport illumination (e.g., from one or more LEDs) within the panel (e.g., from one edge to the other) via total internal reflection. The light guide panel may be perforated (e.g., perforated uniformly or in any suitable spatial pattern) to cause part of the light to escape from the light guide panel and to therefore create a uniform illumination (or an illumination of a desired patterns). Using a light guide panel may allow for extremely high uniformity of illumination.

In some embodiments, device 100 may be configured such that the illumination light provided has a wavelength that is configured for effective imaging of tissue samples (e.g., breast tissue samples), microcalcifications of tissue samples, lymph nodes within tissue samples, other features of tissue samples, and/or biopsy clips in tissue samples. In some embodiments, device 100 may be configured such that the illumination light provided has a wavelength in the SWIR range. In some embodiments, illumination light in one or more of the following ranges may be used.

Device 100 may provide illumination in the SWIR range. Device 100 may provide illumination light having a wavelength of greater than or equal to 920 nm, 940 nm, 960 nm, or 980 nm while less than or equal to 2540 nm, 2560 nm, 2580 nm, or 2600 nm. In addition or alternatively to SWIR-range illumination, device 100 may in some embodiments provide illumination in the NIR range (e.g., greater than or equal to 680 nm, 700 nm, or 720 nm and less than or equal to 920 nm, 940 nm, 960 nm, 980 nm, 1000 nm, or 1020 nm) and/or the visible-light range (e.g., greater than or equal to 380 nm, 400 nm, or 420 nm and less than or equal to 680 nm, 700 nm, or 720 nm).

Device 100 may provide illumination light having a wavelength of approximately 980 nm. The illumination light may have a wavelength of between 970 and 990 nm, or between 960 and 1000 nm. The illumination light may have a wavelength of greater than or equal to 940, 960, 970, 975, 980, 985, 990, 1000, or 1020 nm. The illumination light may have a wavelength of less than or equal to 940, 960, 970, 975, 980, 985, 990, 1000, or 1020 nm. Wavelengths in these ranges (around 980 nm) may correspond to a characteristic water absorption peak, although the absorption peak is much smaller than the ones deeper in the shortwave infrared range. Wavelengths in these ranges (around 980 nm) may scatter more than other wavelength ranges (e.g., those deeper in the shortwave infrared range) described herein.

Device 100 may provide illumination light having a wavelength of approximately 1200 nm. The illumination light may have a wavelength of between 1190 and 1210 nm, or between 1180 and 1220 nm. The illumination light may have a wavelength of greater than or equal to 1160, 1180, 1190, 1195, 1200, 1205, 1210, 1220, or 1240 nm. The illumination light may have a wavelength of less than or equal to 1160, 1180, 1190, 1195, 1200, 1205, 1210, 1220, or 1240 nm. Wavelengths in these ranges (around 1200 nm) may correspond to a characteristic absorption peak for lipids, and water absorption in these ranges may be minimal compared to other parts of the SWIR range.

Device 100 may provide illumination light having a wavelength of approximately 1550 nm. The illumination light may have a wavelength of between 1540 and 1560 nm, or between 1530 and 1570 nm. The illumination light may have a wavelength of greater than or equal to 1510, 1530, 1540, 1545, 1550, 1555, 1560, 1570, or 1590 nm. The illumination light may have a wavelength of less than or equal to 1510, 1530, 1540, 1545, 1550, 1555, 1560, 1570, or 1590 nm. Water may absorb heavily for wavelengths in these ranges (around 1550 nm), and wavelengths in these ranges may scatter far less than the shorter wavelength ranges described above. may correspond to a characteristic absorption peak for lipids, and water absorption in these ranges may be minimal compared to other parts of the SWIR range. Wavelengths in these ranges (around 1550 nm) may also correspond to heavy absorption for collagen.

Device 100 may provide illumination light having a wavelength of approximately 1700 nm. The illumination light may have a wavelength of between 1990 and 1710 nm, or between 1680 and 1720 nm. The illumination light may have a wavelength of greater than or equal to 1660, 1680, 1990, 1695, 1700, 1705, 1710, 1720, or 1740 nm. The illumination light may have a wavelength of less than or equal to 1660, 1680, 1990, 1695, 1700, 1705, 1710, 1720, or 1740 nm. Wavelengths in these ranges (around 1700 nm) may be near the upper limit for wavelengths that can be detected by certain SWIR image sensors. Wavelengths in these ranges (around 1700 nm) may have very heavy water absorption and may scatter less than other parts of the SWIR range (e.g., those parts of the SWIR range described above).

Device 100 may provide illumination light having a wavelength that is within +/−10 nm, +/−20 nm, +/−30 nm, +/−40 nm, or +/−50 nm of an absorption peak of water or lipid. In some embodiments, light at or near a lipid absorption peak around 1200 nm, or light at or near a lipid absorption peak around 1400 nm may be used. In some embodiments, light at or near a water absorption peak around 1450 nm may be used, or light at or near a water absorption peak around 1900 nm may be used. In some embodiments, light at or near a collagen absorption peak around 1200 nm may be used, or light at or near a collagen absorption peak around 1500 nm may be used. It should be noted that absorption peaks for oxyhemoglobin and deoxyhemoglobin are below 700 nm, outside this range. In some embodiments, rather than using illumination light having a wavelength that is near to one or more of the water, lipid, or collagen absorption peaks described herein, device 100 may provide illumination light that is not at or near said absorption peaks, for example by providing illumination light that is outside of 10 nm, +/−20 nm, +/−30 nm, +/−40 nm, or +/−50 nm of an absorption peak of water, lipid, or collagen SWIR imaging may be a powerful tool for imaging deep biological tissue, as it scatters far less than visible or near-infrared (NIR) light. SWIR imaging is able to visualize biological features at a much greater depth than regular visible or NIR imaging. SWIR imaging may be particularly suitable for imaging of tissue samples and/or biopsy clips therein due to the enhanced penetration depth of SWIR light compared to visible-light or NIR light. Regular optical imaging may be limited to imaging features at less than 2 mm tissue depth, while SWIR imaging may be able to image more than 1 cm into tissue. For these reasons, SWIR imaging may be particularly effective, using the devices and methods described herein, for optically imaging tissue samples, optically locating biopsy clips in said samples, and/or optically imaging deep tissue features.

Furthermore, water and lipids, which are significant chemical components in tissue such as breast tissue, both have strong characteristic absorption peaks in the SWIR range, for example as described above. Thus, water and lipids are transparent in the visible and NIR, but are highly absorptive of light in the SWIR range. Thus, imaging at these characteristic wavelengths in the SWIR range may effectively differentiate metal clips from biological tissue made of water and lipid.

In some embodiments, imaging at wavelengths that are at or near absorption peaks for one or more chemicals in certain components of a tissue sample (e.g., within any of the specific ranges specified above) may allow for effective differentiation of the certain components of the tissue sample from other portions of the tissue sample. Thus, for example, imaging at wavelengths that are at or near absorption peaks for water, lipids, or other chemicals present in biological tissue may be effective in differentiating, e.g., calcifications, fat deposits, lymph nodes, tumors, and/or other tissue components from the surrounding tissue. This is because the light may be effectively absorbed by the chemicals for which it corresponds to an absorption peak, allowing the tissue components containing those chemicals to be easily resolved.

In some embodiments, imaging at wavelengths that are not at or near absorption peaks for one or more chemicals in certain components of a tissue sample (e.g., within the SWIR range but not within any of the specific ranges specified above) may allow for effective differentiation of objects such as biopsy clips embedded in the tissue sample. Thus, for example, imaging at wavelengths that are not at or near absorption peaks for water, lipids, or other chemicals present in biological tissue may be effective in differentiating biopsy clips from tissue components such as calcifications, fat deposits, lymph nodes, tumors, and/or other tissue components. This is because the light may effectively penetrate the chemicals in the tissue sample without being absorbed, while the light may be blocked or reflected by the objects (e.g., biopsy clips) embedded in the tissue, thus allowing the objects embedded in the tissue to be easily resolved. Exemplary SWIR wavelength ranges that are not near one or more absorption peaks for certain chemicals commonly included in tissue samples may include:
greater than or equal to 980 nm, 1000 nm, 1020 nm, or 1040 nm while less than or equal to 1140 nm, 1160 nm, 1180 nm, or 1200 nm;
greater than or equal to 1200 nm, 1220 nm, 1240 nm, or 1260 nm while less than or equal to 1490 nm, 1510 nm, 1530 nm, or 1550 nm;
greater than or equal to 1550 nm, 1570 nm, 1590 nm, or 1610 nm while less than or equal to 1640 nm, 1660 nm, 1680 nm, or 1700; or
greater than or equal to 1700 nm, 1720 nm, 1740 nm, or 1760 nm while less than or equal to 2540 nm, 2560 nm, 2580 nm, or 2600 nm.

In some embodiments, image sensor 108 may be any suitable image sensor configured to detect one or more wavelengths of light, including for example light in the SWIR range as described herein. In some embodiments, image sensor 108 may be configured to detect light in the SWIR range only. In some embodiments, image sensor 108 may be configured to detect light in the SWIR range and light in one or more other wavelength ranges, for example the visible light range. In some embodiments, image sensor 108 may include a SONY SWIR sensor. In some embodiments, image sensor 108 may include a TRIEYE CMOS-based SWIR sensor. In some embodiments, image sensor 108 may include an ALLIED VISION Alvium 1800 SWIR/VIS image sensor. Image sensor 108 may be communicatively coupled to one or more processors such as processor 112 and may be configured to generate image data based on the light detected.

In some embodiments, lens 107 (along with any one or more other associated optical components) may be selected and/or configured such that its optical properties are well-suited for imaging tissue samples (and/or biopsy clips in tissue samples) that are positioned atop substrate 104. In some embodiments, optical properties such as focal length, aperture, minimal working distance, and/or imaging resolution, may be considered. Depth-of-focus may be an important property for the devices and use cases described herein, for example because calcifications, nodes, and/or biopsy clips may be located at various different depths inside a specimen being imaged. Because of this, lens 107 (along with one or more other associated optical components) may be selected and/or configured such that device 100 has a large depth-of-focus. In some embodiments, a depth-of-focus of lens 106 may be greater than or equal to 0.5 cm, 1 cm, 2.5 cm, 5 cm, 10 cm, or 15 cm. In some embodiments, a depth-of-focus of lens 106 may be less than or equal to 0.5 cm, 1 cm, 2.5 cm, 5 cm, 10 cm, or 15 cm. In some embodiments, device 100 may include an aperture associated with lens 107; an aperture may be used to improve depth of focus, and may reduce the amount of overall light intensity reaching image sensor 108.

Processor 112 may be configured to receive image data from image sensor 108 and to generate one or more images (e.g., digital representations of images) based on the image data received. Processor 112 may cause said images to be stored, transmitted, and/or displayed, locally and/or remotely. Processor 112 may be configured to analyze one or more of said images, to make one or more determinations based on one or more of said images, and/or to control one or more functions of device 100 in accordance with a determination made based on one or more of said images (e.g., whether one or more trigger conditions is met).

Processor 112 may be configured to control functionality of one or more components of device 100, such as controlling light source 105, image sensor 108, power module 110, and/or display 114, each of which may be communicatively coupled to processor 112. In some embodiments, processor 100 may cause real-time display of images generated based on the light captured by image sensor 108.

Processor 112 may be configured to receive one or more user inputs, which may be executed by a user via an input device (e.g., one or more buttons, knobs, keys, touch-screen interfaces, voice control systems, and/or other user input devices) provided locally as a part of device 100 and/or remotely as a part of a device communicatively coupled to device 100. Processor 112 may be configured to control one or more functions of device 100 in accordance with the user input(s) received.

Device 100 may be configured such that software controlling image detection and/or image processing is configured to allow effective and accurate imaging of tissue, tissue features such as microcalcifications, and/or biopsy clips in tissue. For example, processor 112 may be configured to execute software for controlling image detection and/or image processing in accordance with any one or more of the techniques described herein.

In some embodiments, deice 100 may implement a logarithmic detection system, such that image details can be resolved rather than being overshadowed by high-intensity areas.

In some embodiments, device 100 may implement one or more image background subtraction algorithms. Implementation of an image background subtraction may help to compensate for strong background light, to compensate for non-uniform illumination light, and/or to compensate for non-uniformity in an image detector. Image background subtraction may be used to reduce noise that may be inherent to image sensor 108. Image background subtraction techniques may be understood to include subtraction techniques, division techniques, and/or averaged subtraction techniques.

In some embodiments, processor 112 may be configured to control SWIR light source 105 to implement one or more light modulation schemes. A light modulation scheme may be used to modulate the SWIR illumination light, and may be used to reduce noise in the resulting images. In some embodiments, processor 112 may control SWIR light source 105 along with image sensor 108 to capture multiple images over a short period of time and average or otherwise combine those multiple images to generate a combined image. Various different modulation frequencies and intensities may be used, for example in accordance with system settings, user inputs, and/or environmental conditions.

In some embodiments, device 100 may include one or more polarizers, for example including linear polarizers, circular polarizers, and/or quarter-waveplates. The one or more polarizers may be positioned and configured to improve contrast of the images captured by image sensor 108. In some embodiments, device 100 may be configured for cross-polarization imaging in which a first polarizer is positioned in the optical path of the illumination light and a second polarizer is positioned in an optical path of the detection light, wherein a polarization of the second polarizer is orthogonal (or about orthogonal) to the polarization of the first polarizer. By using cross-polarization imaging, photons that are reflected from the surface or from a shallow depth of the tissue sample, which may have a same or similar polarization as the polarized light incident on the tissue sample, may be blocked by the orthogonal collection-light polarizer; meanwhile, photons that penetrated deep into the tissue sample, which may be substantially or completely depolarized, may be transmitted by the orthogonal collection-light polarizer. In this manner, images of tissue features and/or biopsy clips located deep within the tissue sample may be captured.

In some embodiments, device 100 may be configured to perform imaging of tissue samples on substrate 104 using SWIR light only. In some embodiments, device 100 may be configured to perform imaging of tissue samples on substrate 104 using SWIR light and light in one or more additional wavelength ranges. In some embodiments, SWIR light source 105 may be configured to additionally or alternatively provide illumination (and/or excitation) light in one or more other wavelength ranges. In some embodiments, an additional light source may be included in device 100, in addition to light source 105, to provide illumination (and/or excitation) light in one or more other wavelength ranges. In some embodiments, image sensor 108 may be configured to detect light in one or more other wavelength ranges. In some embodiments, an additional image sensor may be included in device 100, in addition to image sensor 108, to detect light in one or more additional wavelength ranges.

In some embodiments, device 100 may be configured to generate (and display) one or more images based on light detected in a SWIR wavelength range. In some embodiments, device 100 may be configured to generate (and display) one or more images based on light detected in a SWIR wavelength range and based on light detected in a non-SWIR wavelength range. In some embodiments, device 100 may be configured to generate (and display) one or more images based on light detected in a non-SWIR wavelength range.

In some embodiments, device 100 may be configured to provide white-light illumination to a tissue sample disposed on substrate 104 and to generate collect reflected white light to thereby generate a white-light image of the tissue sample. This white-light image capture may be performed simultaneously (or in rapid succession, e.g., on an alternating basis according to one or more automated timing schemes) with SWIR image capture. In some embodiments, device 100 may display a SWIR image of a tissue sample on display 114 (e.g., in real-time) simultaneously with display of an image of the same tissue sample using imaging in a different wavelength range, such as a white-light wavelength range. In some embodiments, display 114 may display two images simultaneously side-by-side for comparison. In some embodiments, display 114 may display two images simultaneously using an overlay display convention (e.g., by rendering one or both images semi-transparently).

In some embodiments, device 100 may have a form factor and/or size configured such that device 100 is portable and amenable to use in an open benchtop setting. In some embodiments, body 102 of device 100 may define a footprint in the x-direction and y-direction that is less than or equal to 50 cm, 40 cm, or 30 cm in either or both the x-direction and y-direction. Device 100 may have an overall height that is less than or equal to 70 cm, 60 cm, 50 cm, 40 cm, 30 cm, 20 cm, or 10 cm. Device 100 may have a weight that is less than 20 lbs, 15 lbs, 10 lbs, 7.5 lbs, or 5 lbs.

In some embodiments, a volumetric region located above the upper surface of body 102 of device 100 may be an open working space that is not occluded by any components of device 100. In some embodiments, a cuboid region above the upper surface of body 102 may be open and unoccluded by any device components. The region may have a width (in the x direction) of greater than or equal to 10 cm, 20 cm, 30 cm, 40 cm, 50 cm, 60 cm, or 70 cm. The region may have a depth (in the y direction) of greater than or equal to 10 cm, 20 cm, 30 cm, 40 cm, 50 cm, 60 cm, or 70 cm. The region may have a height (in the z direction) of greater than or equal to 10 cm, 20 cm, 30 cm, 40 cm, 50 cm, 60 cm, or 70 cm. In some embodiments, device 100 may not include any components located above the upper surface of body 102 and in front of (e.g., in the −y direction) display 114. In some embodiments, device 100 may not include any components located above the upper surface of body 102 and in front of (e.g., in the −y direction) a backmost extent (in the y direction) of substrate 104. In arrangements such as those described, a user may be able to access the working region above the upper surface of device 100 from the front or from either side without being blocked by or having to navigate around any component of device 100.

In some embodiments, positioning light source 105 with respect to substrate 104 may be important to ensure effective and accurate imaging results.

In some embodiments, a beam splitter may be used to combine illumination light and detection light at a 90-degree angle to one another. However, 90-degree beam-splitter combination of illumination and detection light may be difficult when using SWIR light sources, because SWIR light sources may general be very low power compared to light sources in other wavelength ranges. (For example, the highest-power commercially-available SWIR LED may be around 30 mW, while visible light and NIR light LEDs can easily be more than 1 W). By using a beam splitter design, a significant portion of the light (e.g., >75%) may be lost by design. Therefore, it may become particularly challenging to deliver enough SWIR light to the specimen while using a beam splitter design. Furthermore, stray light may present a significant challenge, because the illumination and the detection light share a large portion of the light paths. Further still, the beam-splitter center surface may also cause ghost images, which may be very difficult to remove.

In order to overcome the above challenges associated with 90-degree beam-splitter arrangements, arrangements that illuminate the area of interest from the side (e.g., using an illumination light path that is not parallel to the collection light path). The distances between the LEDs, the specimens, and the mirror may be carefully selected and configured, because when the LEDs are too close to the surface, strong direct reflection may show up in the image and completely overwhelm the signal. However, when the light source is too far away, the illumination may become too weak and the background illumination from regular room light may become too strong, which again overwhelms the signal. In some embodiments, light source 105 may be spaced apart from substrate 104 by a sufficient distance to ensure that illumination light reflected by substrate 104 is not collected in a significant amount by image sensor 108, and by a short enough distance to ensure significantly strong illumination light to generate an effective image that is not overwhelmed by ambient light. Ensuring sufficiently strong illumination light (including by positioning the light source sufficiently close to the underside of the substrate, may be particularly important in open-top designs such as that shown by system 100, because overhead room light may be able to enter the system through the upward-facing substrate.

Furthermore, when selecting the distance by which the SWIR light source should be spaced from the substrate, emission angles of LEDs in the light source may be taken into consideration. Larger beam angles may be helpful in terms of creating homogeneous illumination, but more light intensity may be lost because the peripheral light may not be able to reach the substrate. Smaller beam angles may provide more intensity to the specimen, but may make it far more difficult to create a homogenous illumination pattern.

In some embodiments, light source 105 may comprise LEDs spaced 120 mm away from the center of the imaging area horizontally (e.g., greater than or equal to 100 mm, 105 mm, 110 mm, 115 mm, or 119 mm, or 120 mm; and less than or equal to 120 mm, 121 mm, 125 mm, 130 mm, or 140 mm) and 20 mm away from the center of the imaging area vertically (e.g., greater than or equal to 15 mm, 16 mm, 17 mm, 18 mm, 19 mm, or 20 mm; and less than or equal to 20 mm, 21 mm, 22 mm, 23 mm, 24 mm, or 25 mm). The angle of the illumination may be positioned at 35 degrees from the glass window (e.g., greater than or equal to 25, 30, 32, 34, or 35 degrees; and less than or equal to 35, 36, 38, 40, or 45 degrees).

In some embodiments, the size of substrate 104 may be important to ensure effective and accurate imaging results. A large area for substrate 104 may be required for use with real clinical specimen. One-inch optics may only allow for a field of view of about 50 mm×35 mm, which may be too small for use with real clinical specimens. In some embodiments, transparent substrate may be around 100 mm by 80 mm (e.g., greater than or equal to 90, 95, 98, or 100 mm in width; less than or equal to 100, 102, 105, or 110 mm in width; greater than or equal to 70, 75, 78, or 80 mm in length; and less than or equal to 70, 75, 78, or 80 mm in length. In some embodiments, larger substrate sizes may be used. However, a larger substrate may pose certain risks, including for example: (1) greater risks of shattering and/or (2) exposing the optics to more room light which could overwhelm the signal.

In some embodiments, device 100 may include a plastic enclosure that is molded around substrate 104 to ensure that it is waterproof and will prevent liquids such as water and grease from entering the interior of device 100.

In some embodiments, display 114 may be a touch-screen display configured to allow users to enter inputs via display 114, such that those inputs will be received and processed by processor 112. Using a touch-screen interface via display 114 may save bench space as compared to using a keyboard or mouse to execute inputs.

FIG. 1B is a schematic view of imaging device 100 configured for SWIR illumination and for imaging of a tissue sample, wherein imaging device 100 comprises integrated cutting board 116, in accordance with some embodiments. The embodiment of device 100 shown in FIG. 1B may share any one or more characteristics in common with the embodiment shown and described with reference to FIG. 1A. The embodiment in FIG. 1B may differ from the embodiment of FIG. 1A by the inclusion of cutting board 116 forming a portion of the upper surface of device 100.

Cutting board 116 may be positioned on top of device 100 by being formed integrally as a part of the upper surface of device 100, and/or by being removably positioned in a recessed region formed on the upper surface of device 100 and shaped to receive cutting board 116. The upper surface of cutting board 116 may be flush with an adjacent region of an upper surface of device 100, for example by being flush with an adjacent region of the upper housing of device 100 and/or with substrate 104. Cutting board 116 may form a water-tight seal with an adjacent portion of the upper housing of device 100 and/or with an adjacent portion of substrate 104. Cutting board 116 may be disposed on device 100 in “front” of substrate 104 (e.g., to the right in FIG. 1B), “behind” substrate 104 (e.g., to the left in FIG. 1B), and/or to either side of substrate 104 (e.g., into and/or out of the page in FIG. 1B). Cutting board 116 may be shaped so as to abut substrate 104 on one or more sides of substrate 104, including by, in some embodiments, surrounding substrate 104 on all sides. Cutting board 116 may be positioned such that a specimen may be cut on the cutting board and then may be immediately and safely slid from the cutting board onto the transparent substrate for imaging, without requiring lifting or otherwise transporting the specimen between different devices or different areas in a laboratory.

Cutting board 116 may be removable and replaceable, for example so that it can be cleaned. In some embodiments, cutting board 116 may be made of a high-density plastic material.

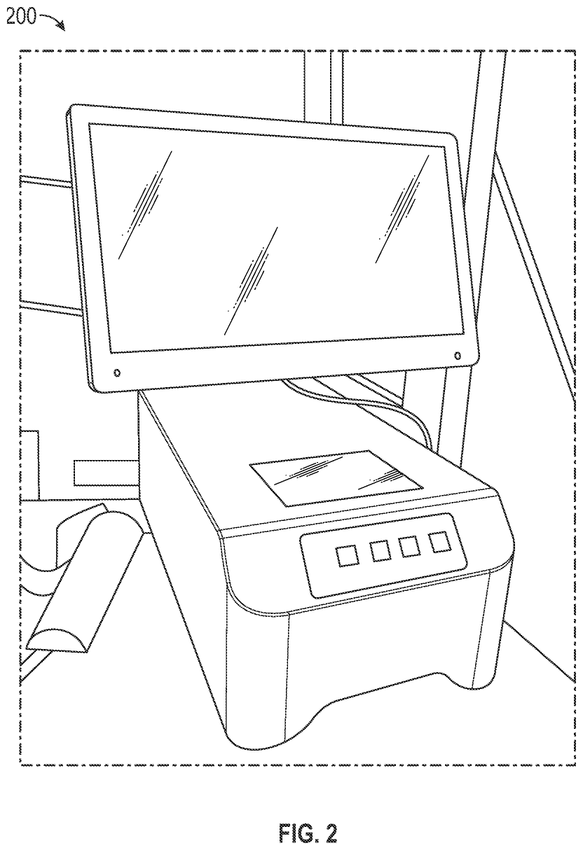

FIG. 2 shows an imaging device 200 configured for SWIR illumination and for imaging of a tissue sample, in accordance with some embodiments. In some embodiments, device 200 and its components may share any one or more characteristics in common with device 100 and its corresponding components. Using device 200, a specimen can be moved on and off the upper surface of the body of the device freely, the device can be cleaned and wiped down easily, and the specimen can be viewed and palpated directly by the handler while it is placed on the transparent substrate.

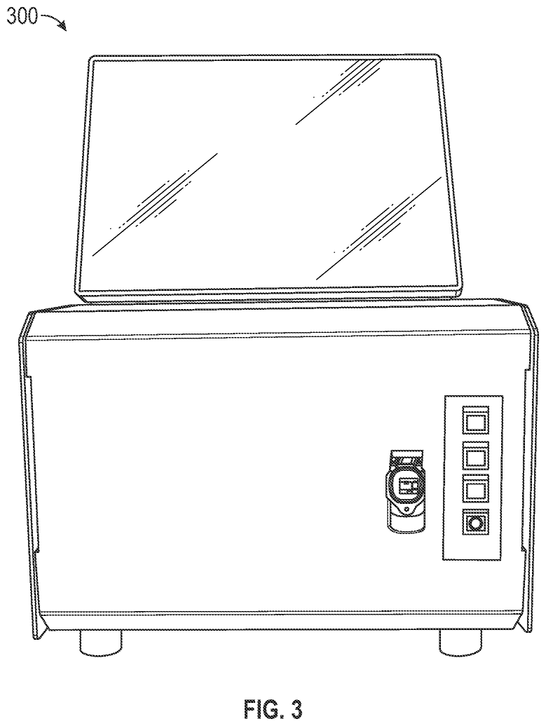

FIG. 3 shows an imaging device 300 configured for SWIR illumination and for imaging of a tissue sample, in accordance with some embodiments. In some embodiments, device 300 and its components may share any one or more characteristics in common with device 100 and its corresponding components and/or with device 200 and its corresponding components. Using device 300, a specimen can be moved on and off the upper surface of the body of the device freely, the device can be cleaned and wiped down easily, and the specimen can be viewed and palpated directly by the handler while it is placed on the transparent substrate. The viewing area of device 300 may be larger than the viewing area of device 200, which may make it more suitable for use with lymph node specimens.

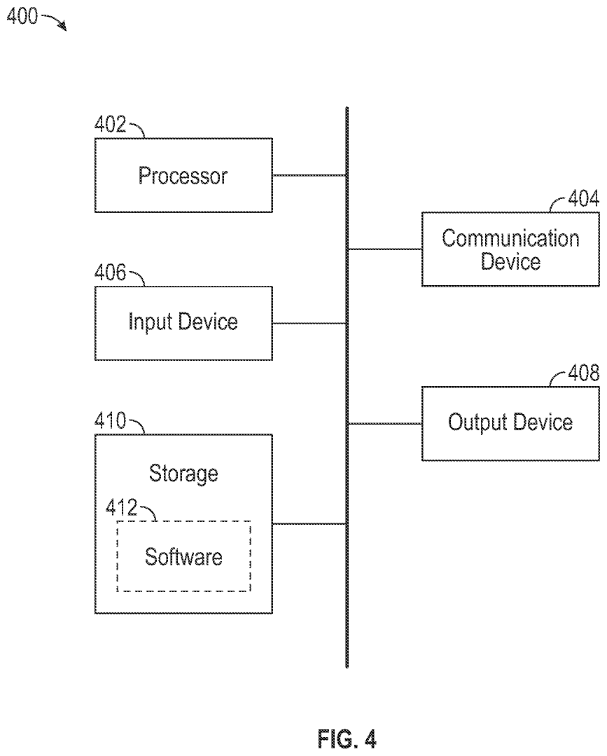

FIG. 4 illustrates a computer 400 according to some embodiments of the present disclosure. In some embodiments, a device for imaging of tissue, such as device 100 and/or device 200 described herein, may comprise a computer (e.g., processor 112 and/or processor 212) that may have any one or more of the characteristics of computer 400. Computer 400 can be a host computer connected to a network. Computer 400 can be a client computer or a server. As shown in FIG. 4, computer 400 can be any suitable type of microprocessor-based device, such as a personal computer, workstation, server, or handheld computing device, such as a phone or tablet. The computer can include, for example, one or more of processor 410, input device 420, output device 430, storage 440, and communication device 460. Input device 420 and output device 430 can either be connectable or integrated with the computer.

Input device 420 can be any suitable device that provides input, such as a touch screen or monitor, keyboard, mouse, or voice-recognition device. Output device 430 can be any suitable device that provides an output, such as a touch screen, monitor, printer, disk drive, or speaker.

Storage 440 can be any suitable device that provides storage, such as an electrical, magnetic, or optical memory, including a random access memory (RAM), cache, hard drive, CD-ROM drive, tape drive, or removable storage disk. Communication device 460 can include any suitable device capable of transmitting and receiving signals over a network, such as a network interface chip or card. The components of the computer can be connected in any suitable manner, such as via a physical bus or wirelessly. Storage 440 can be a non-transitory computer-readable storage medium comprising one or more programs, which, when executed by one or more processors, such as processor 410, cause the one or more processors to execute methods described herein.

Software 450, which can be stored in storage 440 and executed by processor 410, can include, for example, the programming that embodies the functionality of the present disclosure (e.g., as embodied in the systems, computers, servers, and/or devices as described above). In some embodiments, software 450 can include a combination of servers such as application servers and database servers.

Software 450 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 440, that can contain or store programming for use by or in connection with an instruction execution system, apparatus, or device.

Software 450 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 400 can implement any operating system suitable for operating on the network. Software 450 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Exemplary embodiments are described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

In the description herein, it is to be understood that the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems appears from the description herein. In addition, the present disclosure is not described with reference to any particular programming language. It will be appreciated that a variety of programming languages may be used to implement the teachings of the present disclosure as described herein.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

Following is a list of exemplary embodiments, which may in some embodiments be combined in whole or in part with one another and/or with any of the other features or embodiments described herein:
1. A device for short-wave infrared (SWIR) imaging of tissue, comprising:
   a main housing defining an interior cavity and an comprising upper surface, wherein the upper surface comprises a transparent substrate configured to support a tissue sample placed on the transparent substrate atop the main housing of the device;
   a SWIR light source disposed inside the main housing of the device, wherein the SWIR light source is configured to generate SWIR illumination light that is directed through the bottom of the transparent substrate to be incident on the tissue sample disposed atop the transparent substrate;
   an image sensor disposed inside the main housing of the device, wherein the image sensor is configured to collect reflected SWIR light that is reflected by the tissue and passes from above the transparent substrate through the transparent substrate to be incident upon the image sensor;
   one or more processors disposed inside the main housing of the device, wherein the one or more processors are communicatively coupled to the image sensor and configured to generate an image of the tissue sample based at least in part on the reflected SWIR light; and
   a display mounted to the main housing, wherein the one or more processors are configured to cause the display to display the generated image in real-time.
2. The device of embodiment 1, wherein an open working space is provided above the transparent substrate, wherein the open working space is not occluded by any components of the device.
3. The device of any one of embodiments 1-2, wherein the open working space has a footprint with an area of greater than or equal to 1600 cm².
4. The device of any one of embodiments 1-3, wherein: the transparent substrate is disposed on the upper surface of the main housing at a first vertical height and at a first depth in a front-back direction of the device; and
   all components of the device disposed closer to a front of the device than the first depth do not extend above the first height by a distance of greater than 1 cm.
5. The device of any one of embodiments 1-4, wherein:
   the transparent substrate is disposed on the upper surface of the main housing at a first vertical height and at a first depth in a front-back direction of the device;
   the display is mounted at a second vertical height that is higher than the first vertical height; and
   the display is mounted at a second depth that is further from a front of the device than the first depth.
6. The device of any one of embodiments 1-5, wherein the transparent substrate is flush with an adjacent portion of the upper surface of the main housing.
7. The device of embodiment 6, wherein the transparent substrate forms a watertight seal with an adjacent portion of the upper surface of the main housing.
8. The device of any one of embodiments 1-7, comprising:
   a first polarizer positioned in an illumination light path of the SWIR illumination light and configured to impart a first polarization onto the SWIR illumination light; and
   a second polarizer positioned in a collection light path and configured to impart a second polarization onto the light that passes from the imaging region through the transparent substrate to be incident upon the image sensor; wherein
   the first polarization is substantially orthogonal to the second polarization.
9. The device of any one of embodiments 1-8, comprising a white-light source disposed inside the main housing of the device, wherein the white-light source is configured to generate white-light illumination light that is directed through the bottom of the transparent substrate to be incident on the tissue sample disposed on the transparent substrate simultaneously with the SWIR illumination light.
10. The device of embodiment 9, comprising a white-light image sensor disposed inside the main housing of the device, wherein the white-light image sensor is configured to collect reflected white light that is reflected by the tissue and passes from above the transparent substrate through the transparent substrate to be incident upon the image sensor.
11. The device of embodiment 10, wherein the one or more processors are configured to generate the image of the tissue sample based at least in part on the reflected white light.
12. The device of any one of embodiments 10-11, wherein the one or more processors are configured to:
   generate a white-light image of the tissue sample based at least in part on the reflected white light; and
   cause the display to display the generated white-light image simultaneously with display of the image generated based at least in part on the reflected SWIR light.
13. The device of any one of embodiments 9-12, wherein the image sensor is configured to collect reflected white light that is reflected by the tissue and passes from above the transparent substrate through the transparent substrate to be incident upon the image sensor.
14. The device of any one of embodiments 1-13, wherein the SWIR illumination light has a wavelength of one of:
   800-1700 nm;
   1000-1700 nm;
   1500-1700 nm;
   900-1300 nm;
   1000-2600 nm;
   960-1000 nm;
   1180-1220 nm;
   1530-1570 nm;
   1680-1720 nm;
   980-1200 nm;
   1200-1550 nm;
   1550-1700 nm; and
   1700-2600 nm.
15. The device of any one of embodiments 1-14, wherein the upper surface comprises a cutting board configured to support the tissue sample when placed on the cutting board atop the main housing of the device.
16. The device of embodiment 15, wherein the cutting board is recessed within a cavity formed in the upper surface.
17. The device of embodiment 16, wherein the cutting board is removable from the cavity.
18. The device of any one of embodiments 15-17, wherein the cutting board is flush with an adjacent portion of the upper surface of the main housing.
19. The device of embodiment 15-18, wherein the cutting board forms a watertight seal with an adjacent portion of the upper surface of the main housing.
20. The device of any one of embodiments 15-19, wherein the cutting board is flush with an adjacent portion of the transparent substrate.
21. The device of embodiment 15-20, wherein the cutting board forms a watertight seal with an adjacent portion of the transparent substrate.

1. A device for short-wave infrared (SWIR) imaging of tissue, comprising:
a main housing defining an interior cavity and an upper surface, wherein the upper surface comprises a transparent substrate configured to support a tissue sample placed on the transparent substrate atop the main housing of the device;
a SWIR light source disposed inside the main housing of the device, wherein the SWIR light source is configured to generate SWIR illumination light that is directed through the bottom of the transparent substrate to be incident on the tissue sample disposed atop the transparent substrate;
an image sensor disposed inside the main housing of the device, wherein the image sensor is configured to collect reflected SWIR light that is reflected by the tissue and passes from above the transparent substrate through the transparent substrate to be incident upon the image sensor;
one or more processors disposed inside the main housing of the device, wherein the one or more processors are communicatively coupled to the image sensor and configured to generate an image of the tissue sample based at least in part on the reflected SWIR light; and
a display mounted to the main housing, wherein the one or more processors are configured to cause the display to display the generated image in real-time.

2. The device of claim 1, wherein an open working space is provided above the transparent substrate, wherein the open working space is not occluded by any components of the device.

3. The device of claim 1, wherein the open working space has a footprint with an area of greater than or equal to 1600 cm².

4. The device of claim 1, wherein:
the transparent substrate is disposed on the upper surface of the main housing at a first vertical height and at a first depth in a front-back direction of the device; and
all components of the device disposed closer to a front of the device than the first depth do not extend above the first height by a distance of greater than 1 cm.

5. The device of 1, wherein:
the transparent substrate is disposed on the upper surface of the main housing at a first vertical height and at a first depth in a front-back direction of the device;
the display is mounted at a second vertical height that is higher than the first vertical height; and
the display is mounted at a second depth that is further from a front of the device than the first depth.

6. The device of claim 1, wherein the transparent substrate is flush with an adjacent portion of the upper surface of the main housing.

7. The device of claim 6, wherein the transparent substrate forms a watertight seal with an adjacent portion of the upper surface of the main housing.

8. The device of claim 1, comprising:
a first polarizer positioned in an illumination light path of the SWIR illumination light and configured to impart a first polarization onto the SWIR illumination light; and
a second polarizer positioned in a collection light path and configured to impart a second polarization onto the light that passes from the imaging region through the transparent substrate to be incident upon the image sensor; wherein
the first polarization is substantially orthogonal to the second polarization.

9. The device of claim 1, comprising a white-light source disposed inside the main housing of the device, wherein the white-light source is configured to generate white-light illumination light that is directed through the bottom of the transparent substrate to be incident on the tissue sample disposed on the transparent substrate simultaneously with the SWIR illumination light.

10. The device of claim 9, comprising a white-light image sensor disposed inside the main housing of the device, wherein the white-light image sensor is configured to collect reflected white light that is reflected by the tissue and passes from above the transparent substrate through the transparent substrate to be incident upon the image sensor.

11. The device of claim 10, wherein the one or more processors are configured to generate the image of the tissue sample based at least in part on the reflected white light.

12. The device of claim 10, wherein the one or more processors are configured to:
generate a white-light image of the tissue sample based at least in part on the reflected white light; and
cause the display to display the generated white-light image simultaneously with display of the image generated based at least in part on the reflected SWIR light.

13. The device of claim 9, wherein the image sensor is configured to collect reflected white light that is reflected by the tissue and passes from above the transparent substrate through the transparent substrate to be incident upon the image sensor.

14. The device of claim 1, wherein the SWIR illumination light has a wavelength of one or more of:
800-1700 nm;
1000-1700 nm;
1500-1700 nm;
900-1300 nm;
1000-2600 nm;
960-1000 nm;
1180-1220 nm;
1530-1570 nm;
1680-1720 nm;
980-1200 nm;
1200-1550 nm;
1550-1700 nm; and
1700-2600 nm.

15. The device of claim 1, wherein the upper surface comprises a cutting board configured to support the tissue sample when placed on the cutting board atop the main housing of the device.

16. The device of claim 15, wherein the cutting board is recessed within a cavity formed in the upper surface.

17. The device of claim 16, wherein the cutting board is removable from the cavity.

18. The device of claim 15, wherein the cutting board is flush with an adjacent portion of the upper surface of the main housing.

19. The device of claim 15, wherein the cutting board forms a watertight seal with an adjacent portion of the upper surface of the main housing.

20. The device of any one of claims claim 15, wherein the cutting board is flush with an adjacent portion of the transparent substrate.

21. The device of claim 15, wherein the cutting board forms a watertight seal with an adjacent portion of the transparent substrate.
